(19) United States
(12) Patent Application Publication
(10) Pub. No.: US 2025/0328124 A1
(43) Pub. Date: Oct. 23, 2025

(54) METHOD FOR DIGITALLY DESIGNING AND DIGITALLY MANUFACTURING MADE-TO-MEASURE PACKAGING FOR AN OBJECT, MEANS FOR IMPLEMENTING SAID METHOD AND PACKAGING OBTAINED THEREBY

(71) Applicants: Claude BARLIER, Coinches (FR); CIRTES SRC, Saint-Die-Des-Vosges (FR)

(72) Inventors: Claude BARLIER, Coinches (FR); Denis CUNIN, Les Poulieres (FR); Benoït DELEBECQUE, Nayemont Les Fosses (FR)

(21) Appl. No.: 18/724,291

(22) PCT Filed: Dec. 20, 2022
(86) PCT No.: PCT/EP2022/087103

§ 371 Date: Jun. 26, 2024

(30) Foreign Application Priority Data
Dec. 28, 2021 (FR) FR2114580

(51) Int. Cl. G05B 19/4099

(52) U.S. Cl. CPC G05B 19/4099; G05B 2219/49007; G05B 2219/49011

(57) ABSTRACT

The method for digitally designing and manufacturing made-to-measure packaging for an object includes recognizing the object; automatically determining the family of objects to which the object belongs; automatically determining a sub-family to which the object belongs according to the morphology of the object; evaluating the dimensions of the object; determining the packaging model of which the internal volumetric space is capable of containing the object; identifying, locating, defining and quantifying the preferred wedging areas; creating a 3D digital design of the packaging and its preferred wedging areas; digitally decomposing the packaging and its preferred wedging areas by creating different complementary elementary layers by means of digital slicing; reproducing the different layers by cutting a suitable material in sheet form in order to obtain strata, and subsequently stacking and/or juxtaposing, positioning, assembling and securing the different strata to form the packaging.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The object of the present invention is to digitally design and manufacture a made-to-measure packaging for an object, automatically.

### 2. Description of Related Art Including Information Disclosed Under 37 CFR 1.97 and 37 CFR 1.98

It is currently witnessed that there is rapid growth in the shipment of objects, notably due to the existence of mail-order platforms for the resale of second-hand objects, for example.

Generally speaking, it is preferable, and sometimes even mandatory, to transport an object in packaging. When the transport of objects is concerned, two main categories should be distinguished: new objects and non-new objects.

New objects are packaged in their original packaging, which has been designed specifically for the object in question and can therefore meet transport requirements.

For other objects, and sometimes for new objects too, if the original packaging has not been kept, or as is sometimes the case, if there was no original packaging or no individual packaging, shipment by carrier requires the objects to be packaged.

In practice, a box is sought that is large enough to hold the object to be placed inside, then the empty spaces are filled with a filler and/or cushioning product such as loose particles, which can be various materials such as polystyrene, paper, cardboard or inflated bags.

When the object is large and the voids to be filled are significant, this may require a large quantity of filler and/or padding, which represents an additional cost and, above all, for some, a questionable ecological balance, which today can be prohibitive.

To illustrate the problems posed, we can cite the example of shipping a bicycle, whether to deliver a second-hand bike to a buyer, or to send one's own bike to a vacation destination, for example, or for a competition.

Firstly, when a bike is purchased new, it is not packaged, so there is no original packaging. Secondly, packing a bike in a box requires a large box, but not too large to remain within the standards required by the carrier, as well as a significant amount of filler and/or cushioning to fill the void.

Some have tried to solve this problem but failed. Document US 2021/139171 describes a system for optimizing the manufacture of packaging, which consists in particular by evaluating the quantity of cushioning material required, such as wood, bubble wrap, inflated bags, foam, cardboard, paper, plastic or mold-formed padding, in order to reduce the quantity, without however dispensing with the use of this filling and/or cushioning product.

EP 2239210 describes a bicycle transport box designed to accommodate different frame sizes or different types of bicycle frame, that is, the packaging is identical, irrespective of the bicycle to be packed, but the interior fittings can be modified to accommodate different types of bicycle parts. The outer dimensions of the packaging are therefore fixed, and designed to be as large as possible, making it impossible to optimize the overall size.

### BRIEF SUMMARY OF THE INVENTION

The present invention is not limited to the packaging and shipment of bicycles. Another example of use is the shipment of large tools that do not have original packaging, such as, but not limited to, lawnmowers, brush cutters, chainsaws, etc., which need to be packaged for transport.

The purpose of the present invention is to propose a method for digitally designing and manufacturing made-to-measure packaging, as well as the means for implementing said method, and the packaging obtained, enabling secure packaging of the object to be packaged, which can be achieved automatically for most objects likely to be transported, dispensing with the use of filler and/or cushioning, and minimizing the material used.

The method of digitally designing and digitally manufacturing packaging for an object according to the invention, is characterized in that it consists in carrying out the following operations:
recognizing the object to be packaged,
automatically determining the family of objects to which the object belongs,
automatically determining a sub-family to which the object belongs according to the morphology of said object evaluating the dimensions of the object, determining the packaging model of which the internal volumetric space is capable of containing the object,
identifying, locating, defining and quantifying the preferred wedging areas,
creating a 3D digital design of the packaging and its preferred wedging areas,
digitally decomposing the packaging and its preferential wedging areas by means of digital slicing into different complementary elementary layers,
reproducing the different layers by cutting suitable material in sheet form in order to obtain strata,
then stacking and/or juxtaposing, positioning, assembling and securing the different strata to form the packaging.

The method according to the invention enables made-to-measure digital packing, both packaging and wedging, from sheet packing material, with no size limits, thus eliminating the need to accumulate stocks of crates in multiple formats.

The method does not require the entire object to be digitized, but only part of it, that is, preferential wedging areas, in order to optimize the wedging.

According to an additional feature of the digital design method according to the invention, determining the sub-family to which the object belongs according to its morphology consists in identifying common points and singularities, and comparing them with a morphological classification previously carried out.

According to another additional feature of the method according to the invention, the strata are optimally distributed in a kit on one or more sheets.

The kit method optimizes the use of just the right amount of material with a minimum of losses.

According to another additional feature of the digital design method according to the invention, the wedging areas consist of independent elements.

According to another additional feature of the digital design method according to the invention, prior to the 3D digital design operation of the packaging, an additional step is carried out to identify, locate and define one or more protection areas for the object to be packaged.

According to another additional feature of the method according to the invention, the phase of determining the packaging model is associated with an operation of choosing the packaging model from a selection resulting from a typological study.

According to another additional characteristic of the digital design method according to the invention, after the operation of choosing the packaging model, an operation of identifying possible areas of lesser strength of said packaging is incorporated, followed by an operation of modeling reinforcements of said packaging making it possible to correct said possible areas of lesser strength, then an operation of digitally decomposing said reinforcements by digital slicing into different complementary elementary layers so as to integrate the manufacture of said reinforcements with that of said packaging.

According to another additional feature of the digital design method according to the invention, prior to the cutting operation, the identification of each of the strata is carried out, and an assembly instruction manual is drawn up.

Such an operation facilitates the assembly of the packaging, given that the various parts that make up the packaging may be numerous and come from several sheets.

The packaging data can also be stored electronically, for example for transmission from the design location to the assembly location, which may be remote. It is also possible to store data for reuse when an identical object is detected for packaging, since this stored data can always be modified as part of the object's evolution.

According to another additional feature of the digital design method according to the invention, the suitable material consists of cardboard, or other biosourced, recyclable materials in sheets.

According to another additional feature of the digital design method according to the invention, the different layers are joined together by gluing and/or interlocking and/or locking with a locking key.

According to another additional feature of the digital design method according to the invention, during the cutting operation, openings are created to facilitate carrying the packaging.

Such cut-outs can be created in the packaging walls to allow a hand to pass through.

According to another additional feature of the digital design method according to the invention, during the cutting operation, means are created for securing the various elements together.

For example, tenon/mortise type systems can be cut into the sheets, or locked with a locking key, allowing easy disassembly.

It should be noted that, particularly in the case of large packages, it is planned to finalize the manufacture of the package by a strapping operation, whether with one or more straps or adhesive tape, possibly by shrink-wrapping.

The present invention also relates to the means for implementing the digital design method according to the invention, which consist in means for detecting and recognizing the object to be packaged, means for taking measurements of said object, computer means associated with one or more software programs for designing said packaging and for digitally decomposing said packaging by digital slicing into different complementary elementary layers, and means for transmitting to sheet cutting means with a view to creating a kit.

According to an additional feature, the means for implementing the method also comprise automatic assembly means.

All the means used can of course be managed by a PLC.

Even if the assembly of the packaging and the positioning of the object to be packaged could be automated or robotized, these operations are still carried out manually, for obvious reasons of cost.

It is, however, conceivable that certain operations can be carried out mechanically, such as assembling the layers intended to form the wedging and/or reinforcement means.

The advantages and features of the digital design method and of the device according to the invention will emerge more clearly from the description which follows, and which relates to the appended drawing, which shows one non-limiting embodiment thereof.

The following description relates in no way restrictively to the creation of packaging for a bicycle, and can of course be applied to the creation of packaging for other objects.

### BRIEF DESCRIPTION OF THE SEVERAL VIEWS OF THE DRAWINGS

FIG. 1 shows a schematic perspective view of a model of a bicycle to be packaged using the digital design method according to the invention.

FIG. 2 shows schematic and perspective views A, B and C of successive steps of modeling the packaging to be produced.

FIG. 3 shows a schematic perspective view of a packaging manufacturing step, in particular the forming of kits.

FIG. 4 shows a schematic perspective view of a subsequent packaging construction step.

FIG. 5 shows a schematic perspective view of the bicycle being packed.

FIG. 6 shows a schematic perspective view of the finished packaging.

### DETAILED DESCRIPTION OF THE INVENTION

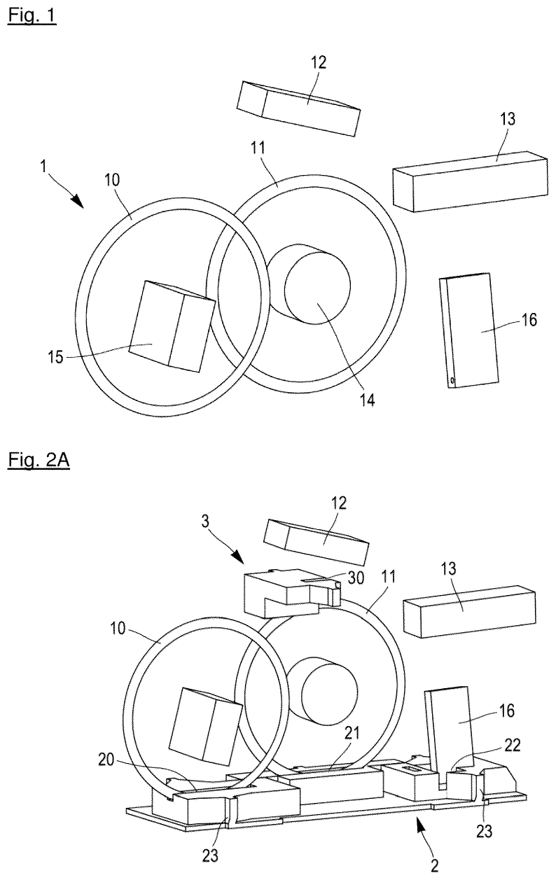

With reference to FIG. 1, a schematic representation of a bicycle for which packaging is to be produced can be seen, using the digital design method according to the invention.

Prior to this modeling, preliminary operations will have been carried out, that is, recognizing the object to be packaged, determining the family of objects to which said object belongs, and identifying within said family the sub-family in which said object can be classified. As the method is suitable for all types of objects, it is necessary to narrow down the possibilities beforehand. Thus, once a bike has been recognized and the search limited to the bike family, the sub-family is automatically determined by a morphological study, that is, a racing bike, a mountain bike or a city bike. The dimensions of the bike can then be evaluated. This operation is performed after the sub-family search operation, since some measurements may be more important than others.

The automatic determination of the sub-family sought by the morphological study is important, since it eliminates the need to take a large number of measurements. In fact, by identifying a sub-family, this can be limited to a few measurements, mainly concerning the frame and/or sensitive technical parts.

FIG. 1 shows a model of a bicycle 1, showing the rear wheel 10, the front wheel 11, the saddle 12, the handlebars 13, the crankset 14, the derailleur 15 (if included) and the front fork 16. According to the invention, in the case of a bicycle, it is foreseen that the latter is, at least in part, disassembled; in this case the front wheel 11 is disassembled.

All these elements are represented by volumes designed to contain them, so that the free space can be used for wedging.

Note that the bicycle frame is not modeled, since it is necessarily smaller than the wheels, and its thinness is negligible compared to, for example, the transverse dimension of the crankset.

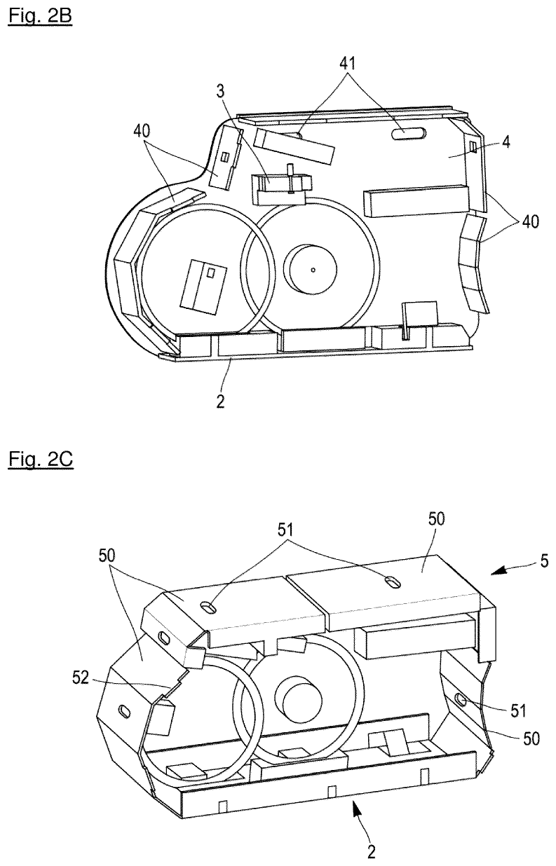

The next step, shown diagrammatically in FIG. 2A, is to model the bike's wedging areas, based on known sub-family data and actual measurements. In this instance, it essentially involves creating a base 2 of a certain thickness, comprising a groove 20 for receiving the rear wheel 10, a groove 21 for receiving the removed front wheel 11, and a recess 22 for receiving the free end of the bicycle fork 16.

Note that the base 2 also features structural elements designed to stiffen the packaging, consisting of spacers 23 designed to be arranged transversely to support the side walls of the packaging (not shown).

Also created is an element 3, intended for clamping the saddle 12, and which in this case comprises a groove 30 for receiving the stem, not shown, of the saddle 12, which can optionally comprise grooves for receiving at least one wheel, for example the front wheel 11, and which has a dimension in the transverse direction, suitable for bracing the side walls, not shown, of the packaging, in order to prevent crushing thereof.

The next step, diagrammed in FIG. 2B, involves modeling a side wall 4 and transverse bracing elements 40, distributed around the periphery. In conjunction with the spacers 23 and element 3, these transverse elements 40 provide anti-crushing means in the transverse direction.

The next step, shown in FIG. 2C, consists in modeling a peripheral wall 5, attached to wall 4, and more precisely the flanks 50 that are to make it up, while the next step, not shown, consists in creating the second side wall, which in this case can be identical to side wall 4.

These various models also determine the location and number of openings 41 in wall 4 and 51 in wall 5, designed to form handles for carrying the packaging.

It will be noted that with a view to quick and easy assembly, both wall 4 and the wall facing it can be provided with slot-type openings, into which tongues 52 can be inserted at the edges of the sidewalls 50, as shown in FIG. 2C, to enable interlocking assembly.

After modeling the entire package, the various parts to be produced are digitized, that is, on the one hand the flat parts such as the walls, and on the other hand the parts with a certain volume, the wedging areas such as the base 3 and the element 30. While flat parts are digitized to determine their contours, volume parts are decomposed by digital slicing into different complementary elementary layers, so that these volume parts can be reproduced by stacking these complementary elementary layers.

Once the packaging has been broken down digitally, the individual parts are arranged in one or more kits, with the aim of optimizing and making the most of the material used.

This material is essentially cardboard, packaged in sheets 6, as shown in FIG. 3. This figure shows such a cardboard sheet or sheet 6, arranged on a cutting table 7, equipped with a multi-axis cutting means, which enables the cardboard sheet or sheeting 6 to be traced and cut according to a kit 60, to create flat elements 61 for assembly.

Of course, the method is not limited to the use of cardboard sheets, and it is perfectly possible to choose other materials that can be packaged in sheets, preferably, but not exclusively, bio-sourced and/or recyclable.

It should be noted that, prior to or at the same time as this cutting operation, it is possible to mark the various parts of the kit 60, by printing for example, for the purpose of identifying the elements 61 during assembly.

In addition, the cutting table 7 is supplied with sheets 6, stored in a rack, enabling continuous production.

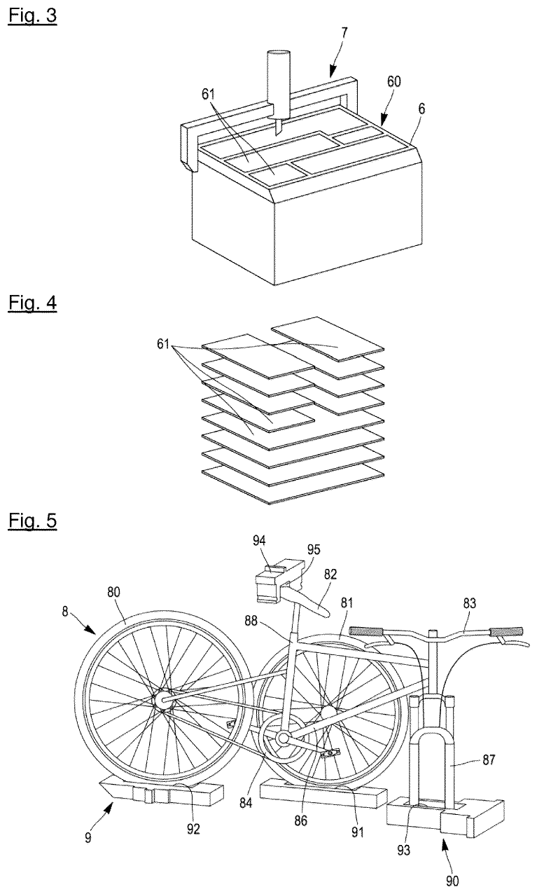

Referring now to FIG. 4, we can see in schematic form the operation which consists in stacking elements 61 forming the layers of a voluminous part of the packaging, these elements being assembled and secured by an operation such as, but not limited to, gluing.

It should also be noted that, depending on the packaging to be produced, it may be necessary to carry out one or more creasing operations on certain elements 61 intended to comprise one or more folds.

FIG. 5 shows a step in the operation of packaging the bicycle 8 to be packed with a packaging 9 resulting from the assembly of the various elements 61 from the kit 60.

The parts of the bicycle 8 can be seen: rear wheel 80, front wheel 81, saddle 82, handlebars 83, crankset 84 and derailleur 85, as well as frame 86, front fork 87 and seat post 88.

The packaging 9 has the same features as the model packing, and the figure shows a base 90 which has a groove 91 to receive the rear wheel 80, a groove 92 to receive the front wheel 81 when disassembled, and a recess 93 to receive the free end of the fork 87, and which is shaped like a groove parallel to the grooves 91 and 92, so as to hold the fork 87 in a 90° rotated position, and thus to orient the handlebars 83 in the longitudinal direction.

The packaging 9 also includes a wedging element 94, designed to form a spacer, and comprising a recess 95 straddling the saddle 82, which could also include a groove engaging saddle post 88.

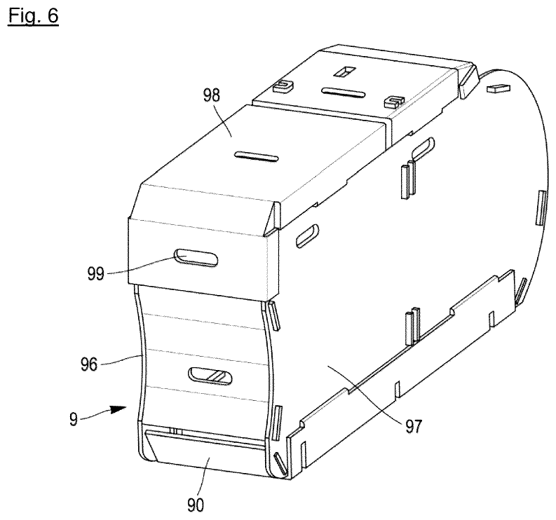

Referring now to FIG. 6, we can see the finished package 9 with its two outer walls 96 and 97, its peripheral wall 98, and carrying handles 99. A final strapping operation, not shown here, consolidates the assembly prior to shipment.

All the operations described above are of course controlled by dedicated software, and form part of a complete continuous digital chain.

I claim:

1. A method for digitally designing and manufacturing a made-to-measure packaging, the method comprising the step of:
recognizing an object to be packaged
automatically determining a family of objects to which said object belongs;
automatically determining a sub-family to which said object belongs according to the morphology of the object;
evaluating the dimensions of said object;
determining the packaging model of which the internal volumetric space is capable of containing said object;
identifying, locating, defining and quantifying preferential wedging areas;
creating a 3D digital design of the packaging and its preferential wedging areas;
digitally decomposing said packaging and its preferential wedging areas by digital slicing into different complementary elementary layers;
reproducing said different layers by cutting operations in suitable material packed in sheets in order to obtain strata; and
then stacking and/or juxtaposing, positioning, assembling and securing said different layers to form said packaging.

2. The method of digitally designing and manufacturing, according to claim 1, wherein the step of determining the family to which the object belongs, as a function of its morphology, comprising the steps of: identifying common points and singularities, and comparing them with a morphological classification previously carried out.

3. The method of digitally designing and manufacturing, according to claim 1, wherein the strata are optimally distributed in a kit on one or more sheets.

4. The method of digitally designing and manufacturing, according to claim 1, wherein the wedging areas are comprised of independent elements.

5. The method of digitally designing and manufacturing, according to claim 1, further comprising, prior to the 3D digital design operation of the packaging, an additional step of identifying, locating and defining one or more protective areas of the object to be packaged is carried out.

6. The method of digitally designing and manufacturing, according to claim 1, wherein the step of determining the packaging model is associated with an operation of choosing the packaging model from a selection resulting from a typological study.

7. The method of digitally designing and manufacturing, according to claim 6, wherein, after the operation of choosing the packaging model, an operation of identifying any areas of lesser strength of said packaging is incorporated, followed by an operation of modeling the reinforcements of said packaging, enabling said areas of lesser strength to be corrected, and then an operation of digitally decomposing said reinforcements by digital slicing into different complementary elementary layers, so as to integrate the manufacture of said reinforcements with that of said packaging.

8. The method of digitally designing and manufacturing, according to claim 1, wherein, prior to the cutting operation, each of the strata is identified, and assembly instructions are drawn up.

9. The method of digitally designing and manufacturing, according to claim 1, wherein the suitable material is comprised of cardboard or other recyclable, bio-based materials.

10. The method of digitally designing and manufacturing, according to claim 1, wherein the different layers are joined together by a gluing and/or interlocking and/or key-locking operation.

11. The method of digitally designing and manufacturing, according to claim 1, wherein, during the cutting operation, openings are created to facilitate the carrying of the packaging.

12. The method of digitally designing and manufacturing, according to claim 1, wherein, during the cutting operation, means are created for securing the various elements together.

13. A device for digital design and manufacturing, comprising:
means for detecting and recognizing the object to be packaged,
means for taking measurements of said object,
computer means associated with one or more software programs for designing said packaging and for digitally decomposing said packaging by digital slicing into various complementary elementary layers, and
means for transmitting to means for cutting sheets, with a view to creating a kit.

14. The device for digital design and manufacturing, according to claim 13, wherein the means for implementing the method also comprise automatic means for assembling the packaging.

15. An assembly, comprising: packaging designed and manufactured according to the method of claim 1.
